(19) United States
(12) Patent Application Publication
(10) Pub. No.: US 2026/0134794 A1
(43) Pub. Date: May 14, 2026

(54) AI-POWERED CAR SALES TRAINING SYSTEM

(71) Applicants: Eric Michael Schmidt, Lynnwood, WA (US); Michael Dean Schmidt, Lynwood, WA (US)

(72) Inventors: Eric Michael Schmidt, Lynnwood, WA (US); Michael Dean Schmidt, Lynwood, WA (US)

(21) Appl. No.: 19/382,522

(22) Filed: Nov. 7, 2025

Related U.S. Application Data
(60) Provisional application No. 63/718,496, filed on Nov. 8, 2024.

(51) Int. Cl. G09B 19/00; G06F 3/01; G09B 5/02

(52) U.S. Cl. CPC G09B 19/00; G06F 3/011; G09B 5/02

(57) ABSTRACT

An AI-powered car sales training system configured to teach car sales personnel how to sell cars is disclosed. The AI-powered car sales training system uses artificial intelligence (AI) to dynamically respond to input and evaluate the learner's performance. For example, the AI-powered car sales training system will provide interactive scenarios for learners to explore and interact with. The scenario characteristics, behaviors, and context will change based upon the learner's responses. Additionally, because the AI-powered car sales training system can be provided as a service to individual, unique car dealerships, the service can be tailored to the context and environment of the learner's actual place of work.

### CLAIM OF BENEFIT TO PRIOR APPLICATION

This application claims benefit to U.S. Provisional Patent Application 63/718,496, entitled “AI-POWERED CAR SALES TRAINING SYSTEM CONFIGURED TO TEACH CAR SALES PERSONNEL HOW TO SELL CARS,” filed Nov. 8, 2024. The U.S. Provisional Patent Application 63/718,496 is incorporated herein by reference.

### BACKGROUND

Embodiments of the invention described in this specification relate generally to sales education systems, and more particularly, to technological ways to teach professional sales personnel the basic and advanced knowledge involved in car sales.

Car dealerships have a high turnover of sales people. As a result, they frequently need to train new salespeople on the fundamentals of customer service and sales. If they assign a more experienced salesperson to train new employees (allowing that an experienced salesperson is available), then they lose the effort of that sales person. If they pay for a sales training seminar, the cost is prohibitive and the information is not specific to their products.

Most online training programs rely on videos and static content for training. This content does not change depending on inputs from the learner.

Therefore, what is needed is a way to utilize technology to teach sales personnel how to sell cars in customized ways according to the individual knowledge, experience, and/or intuitions of a sales person, and to provide a system as a service to individual car dealerships (unique as they are from each other), and where the service can be tailored to the context and environment of any learner's actual place of work.

### BRIEF DESCRIPTION

A novel artificial intelligence (AI)-powered car sales training system is disclosed. In some embodiments, the AI-powered car sales training system teaches car sales personnel how to sell cars. In some embodiments, the AI-powered car sales training system uses a large language model (LLM) and an AI algorithm to dynamically respond to input and evaluate performance of a user (or “learner”). Additionally, because the AI-powered car sales training system can be provided as a service to individual, unique car dealerships, the service can be tailored to the context and environment of the learner's actual place of work.

In some embodiments, the AI-powered car sales training system comprises a backend server, subject matter expert (SME) database, an AI/ML model (LLM), a chatbot, an API layer/service, a web app or website, and a machine learning (ML) pipeline. In some embodiments, the learners are users of the AI-powered car sales training system and connect to the AI-powered car sales training system via one or more devices. Examples of the types of devices include, without limitation, enhanced reality devices (such as VR goggles, AR eyewear, and other enhanced vision device), mobile devices (such as iOS mobile devices with an iOS mobile app, Android mobile devices with an Android mobile app, traditional computing devices, such as desktop computers, laptop computers, and other computing devices running desktop applications (“desktop app”) and/or web apps.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a schematic diagram of an architecture of an AI-powered car sales training system that teaches car sales personnel how to sell cars in some embodiments.

FIG. 2 conceptually illustrates a process for providing an AI-powered car sales training system to teach car sales personnel how to sell cars in some embodiments.

FIG. 3 conceptually illustrates a cloud-based architecture of an AI-powered car sales training system that hosts a cloud application service in some embodiments.

FIG. 4 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Embodiments of the invention described in this document include a novel AI-powered car sales training system which is configured to teach car sales personnel how to sell cars. In some embodiments, the AI-powered car sales training system comprises a subject matter expert database (SME database), a large language model (LLM), a chatbot, an application programming interface (API), an AI algorithm that is interactive via a public interface connection to a cloud application service, and a data sourcing agent configured to provide SME data retrieved from the SME database. In some embodiments, the AI-powered car sales training system uses the LLM, the AI algorithm, the API, and data from the SME database to dynamically respond to input and evaluate the learner's performance. For example, the AI-powered car sales training system will provide interactive scenarios for learners to explore and interact with. The scenario characteristics, behaviors, and context will change based upon the learner's responses. Additionally, because the AI-powered car sales training system can be provided as a service to individual, unique car dealerships, the service can be tailored to the context and environment of the learner's actual place of work.

As stated above, most car dealerships have a high turnover of sales people. As a result, they frequently need to train new salespeople on the fundamentals of customer service and sales. If they assign a more experienced salesperson to train new employees (allowing that an experienced salesperson is available), then they lose the effort of that sales person. If they pay for a sales training seminar, the cost is prohibitive and the information is not specific to their products. Embodiments of the AI-powered car sales training system described in this specification solve such problems by providing an easy, customized, and interactive system that allows new salespeople to learn customer service and sales in a virtual environment, where the learning environment can be self-paced, so new salespeople do not need to rely on another salesperson to train them. In some embodiments, the AI-powered car sales training system supports any computing or mobile device operable by any sales person. In some embodiments, these users/learners (the sales personnel) interact with client-side mobile app or software in which learning is entirely based on online connection to a backend cloud application service or website. Accordingly, any dealership is able to deploy a local version of the AI-powered car sales training system on a server/network of the dealership. While in other scenarios, dealerships can be directed to a provider which hosts this via network connection to the cloud. In this way, dealerships need not pay for training seminars outside of the dealership, since personnel are able to “connect” and “interact” to pace through their respective training as needed.

Embodiments of the AI-powered car sales training system described in this specification differ from and improve upon currently existing options. Among the existing options, static content like videos, worksheets, and manuals do not evolve with changes in the market. Furthermore, they cannot automatically tailor themselves to each learner's individual needs. By contrast, the AI-powered car sales training system is entirely online, therefore learners do not need to leave their place of work for training. The AI-powered car sales training system delivers learning content on-demand and is self-paced, so it does not require additional dealership personnel (e.g., more experienced salespeople) to deliver the training. In some embodiments, the AI used in the AI-powered car sales training system reads input from the learner/user and responds appropriately. For example, the AI-powered car sales training system will provide interactive scenarios for learners to explore and play with. The scenario characteristics, behaviors, and context will change based upon the learner's responses. Finally, because the AI-powered car sales training system delivers content as a service, dealerships can pay for training on a subscription basis rather than a per-person/seat at a training seminar.

The AI-powered car sales training system of the present disclosure may be comprised of the following elements. This list of possible constituent elements is intended to be exemplary only and it is not intended that this list be used to limit the AI-powered car sales training system of the present application to just these elements. Persons having ordinary skill in the art relevant to the present disclosure may understand there to be equivalent elements that may be substituted within the present disclosure without changing the essential function or operation of the AI-powered car sales training system.
1. A database (also referred to as the subject matter expert database or “SME database”) that stores raw information (data) from a car sales expert. The SME database is a cloud database that is hosted in the cloud by a cloud provider (also referred to as the cloud application service).
2. A large-language model (LLM) that has been fine-tuned (customized). This will be stored within a cloud provider blob storage or container.
3. A chatbot that mediates interactions between the learner and the LLM. This will be hosted on a cloud provider.
4. An API service that receives data from the learner, passes the data to the chatbot, and then provides the chatbot's response back to the learner. This will be hosted on a cloud provider.
5. A website/web app. This will be hosted on a cloud provider.
6. Mobile apps, one on iOS and another on Android. These will be uploaded to the corresponding app stores.
7. An enhanced reality program or game (e.g., an augmented reality (AR) program or game, a virtual reality (VR) program or game, or a mixed reality (XR) program or game). This will be uploaded to the corresponding game/app store(s).
8. An AI-based, machine learning (ML) pipeline hosted on a cloud provider.

The various elements of the AI-powered car sales training system of the present disclosure may be related in the following exemplary fashion. It is not intended to limit the scope or nature of the relationships between the various elements and the following examples are presented as illustrative examples only. The SME database stores a large amount of data drawn from interviews and sales aids prepared by a car sales expert (who is, by definition, a subject matter expert “SME”). The data in the SME database is used to train and retrain (fine-tune) the LLM. The LLM contains the AI logic that the chatbot interacts with. The chatbot will send queries to the LLM and read its responses. The API service provides the communication between the learner's client device and the website (or mobile gateway) for mobile app, or between the augmented reality (AR) game and the chatbot. The website provides a user interface (UI) for the learner to interact with and provides administrative capabilities for managing the subscriptions, payments, etc. The mobile app and the AR game will provide additional UI surfaces for learners to use. Finally, the AI-based, ML pipeline collects data input by the users and puts it back into the SME database. This data is used to re-tune (retrain) the LLM model or to ground responses from the LLM at runtime using a process called retrieval augmented grounding (RAG).

The AI-powered car sales training system of the present disclosure generally works by way of an LLM that has been trained to simulate the knowledge and experience of a car sales expert (SME). It provides realistic feedback to the learners based upon the experience and knowledge gathered from the SME. The data in the SME database includes all of the experience and knowledge gathered from the SME. This data is used to fine-tune the LLM, thereby customizing the model and adjusting its weights based upon the SME's experience and knowledge. The fine-tuning process will occur at regular intervals, to ensure that the model's weights remain fresh. Additional fine-tuning is aided through data collected by the pipeline.

Once the LLM has been tuned, it is hosted/stored on a cloud service. Also hosted within the cloud service is the chatbot, which sends queries to the LLM and formats its responses. The chatbot will receive queries from the API service and return the LLM responses back to the API service. The API service allows the client applications, that is, website, mobile app, and AR program/game to interact with the chatbot over the internet. The API service accepts messages from the client applications, passes the messages to the chatbot, and then passes the chatbot's responses back to the client applications. Finally, the ML pipeline collects data—user input and LLM responses—from the chatbot and then stores the data back in the SME database.

To make the AI-powered car sales training system of the present disclosure, a car sales expert (the subject matter expert, or “SME”) would be ideal to provide the fundamental information or detailed car sales process data needed to fill the SME database with relevant training data which newer car sales personnel can learn from. Furthermore, it is advantageous to have a software/ML engineer, or a team of software developers, for the website, mobile app, API, ML pipeline, the chatbot, the LLM, etc.

To set up and deploy the AI-powered car sales training system, the process begins by the SME providing sales aids, true sales anecdotes, training documents, and other textual forms of knowledge to the SWE. The SWE inputs the data collected from the SME into the SME database. Once the SME database contains enough information, the software engineer may use an off-the-shelf, open-source LLM like GPT-3 or BERT as the foundational model for the LLM. The engineer would then tune the foundational model based upon the data stored in the SME database. The result is a customized, fine-tuned LLM that can respond to input similar to how the engineer might respond. After the LLM is customized, the engineer uploads the LLM to a cloud service provider for storage. Next, the engineer creates a chatbot to interact with the LLM. This chatbot is also uploaded/hosted on the cloud service provider. After the chatbot is created, the engineer then builds the API service to interact with the chatbot. The API service is also uploaded/hosted on the cloud service provider. Next, the engineer creates the website to act as the user interface for the API service. The website allows learners to log in, interact with the chatbot+LLM (AI) over the internet, get scores for their performance, and pay for their subscription. Next the engineer creates the mobile app, for deployment on typical mobile operating systems, such as iOS and Android. To do so, the engineer may utilize a user interface toolkit that can output apps for multiple operating systems from the same (single) codebase. Then the engineer may build the AR program/game. The engineer may define visual hotpoints over the image/view of a car. The engineer also defines the behavior of the AR game so that learner input—which includes both audio/verbal and visual data—is passed to the AI.

Finally, the engineer may create the ML pipeline to collect data from the user input. The engineer may include a step in the chatbot's response routine where the input from the user and the response from the model is transferred into the SME database. The engineer will design user interface to be suitable for the environment on which it runs, namely, for iOS, Android, web browser, etc.

To use the AI-powered car sales training system of the present disclosure, new salespeople and sales managers/personnel (salespeople) view new situations and questions generated by the AI (i.e., chatbot and LLM). The new salespeople react to the respective scenario and their reactions are sent back to the AI through the API service. The AI responds to the input from the new salespeople and then modifies and updates the scenario accordingly.

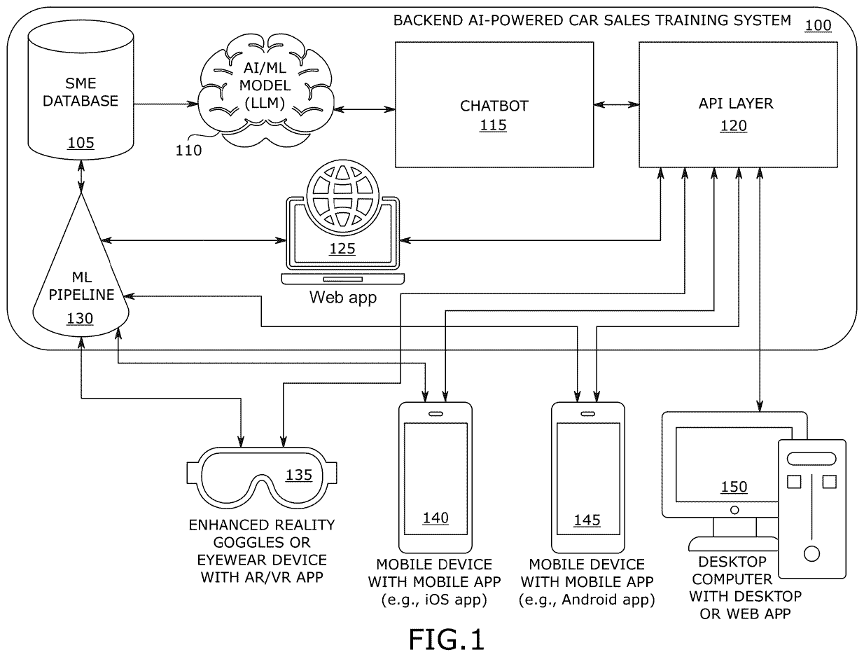

By way of example, FIG. 1 conceptually illustrates a schematic diagram of an architecture of an AI-powered car sales training system 100 that teaches car sales personnel how to sell cars. As shown in this figure, the AI-powered car sales training system 100 is a backend AI-powered car sales training system 100 comprising a plurality of backend components. In particular, the backend components comprise an SME database 105, an AI/ML model (LLM) 110, a chatbot 115, an API layer 120, a web app 125, and an ML pipeline 130. A plurality of user devices are also shown in this figure connecting to the backend AI-powered car sales training system 100. Specifically, the user devices include an enhanced reality device 135, a first mobile device 140, a second mobile device 145, and a desktop computer 150.

The enhanced reality device 135 may be enhanced reality goggles or another type of eyewear device (e.g., smart glasses). The enhanced reality device 135 may be suitable for a particular enhanced reality experiences, such as virtual reality (VR), augmented reality (AR), or mixed reality (XR). As such, the enhanced reality device 135 can be VR goggles, AR goggles, or XR goggles. To operate in connection with the backend AI-powered car sales training system 100, the enhanced reality device 135 may have an AR/VR app installed. Alternatively, the AR/VR app may be installed on a mobile device that is operable by a user who wears the enhanced reality device 135. In that case, the mobile device would be communicably connected to the enhanced reality device 135 and configured to stream AR/VR app content from the mobile device to the enhanced reality device 135 at runtime. Also, the AR/VR app provides the visual output through which the user is able to view and interact with the backend AI-powered car sales training system 100. In particular, the AR/VR app utilizes the API layer 120 to facilitate all interactions between the backend AI-powered car sales training system 100 and the user. To do so, the enhanced reality device 135 or the associated mobile device wirelessly connects to the backend AI-powered car sales training system 100 while running the AR/VR app. Also, access to the ML pipeline 130 is directly provided via the AR/VR app for the enhanced reality device 135.

The first mobile device 140 and the second mobile device 145 may be different types of mobile devices. In this figure, the first mobile device 140 is an iOS device while the second mobile device 145 is an Android device. Thus, an iOS app is installed on the first mobile device 140 and an Android app is installed on the second mobile device 145. Also, the iOS app and the Android app provide the respective user interfaces through which the users interact with the backend AI-powered car sales training system 100. In particular, the iOS app and the Android app utilize the API layer 120 to facilitate all interactions between the backend AI-powered car sales training system 100 and the respective users. To do so, the first mobile device 140 and the second mobile device 145 are configured to wirelessly connect to the backend AI-powered car sales training system 100 while running the iOS app and the Android app, respectively. Also, access to the ML pipeline 130 is directly provided via the iOS app running on the first mobile device 140 and the Android app running on the second mobile device 145.

The desktop computer 150 may be a conventional personal computer (PC), a laptop, or another type of computing device, such as a single board computer (SBC), etc. The desktop computer 150 provides an interface for the user to interact with the backend AI-powered car sales training system 100, either via the desktop app or a web app that runs in a browser program running on the desktop computer 150. Whichever form of app is installed and/or utilized by the user, the app running on the desktop computer 150 connects to the API layer 120 to provide this interactive session for the user. Notably, the web app 125 is triggered by the API layer 120 when the user is operating the desktop computer 150. Thus, the web app 125 provides the connection to the ML pipeline 130.

In the backend, the API layer 120 triggers a new chatbot session to start for each individual user connection. Thus, the API layer 120 initiates the chatbot 115 which provides the user-facing interaction on the respective user device, either the enhanced reality goggles 135, the first mobile device 140, the second mobile device 145, and/or the desktop computer 150. In addition, the chatbot 115 is directly connected to the AI/ML model (LLM) 110 and, therefore, provides the AI-based results of any interaction back to the corresponding user/device. The SME database 105 provides the fundamental training dataset for the AI/ML model (LLM) 110 and the ML pipeline 130. Notably, the SME database 105 is updated as needed on a continuing basis. As a result of the updated training data in the SME database 105, the AI/ML model (LLM) 110 is periodically retained and updated.

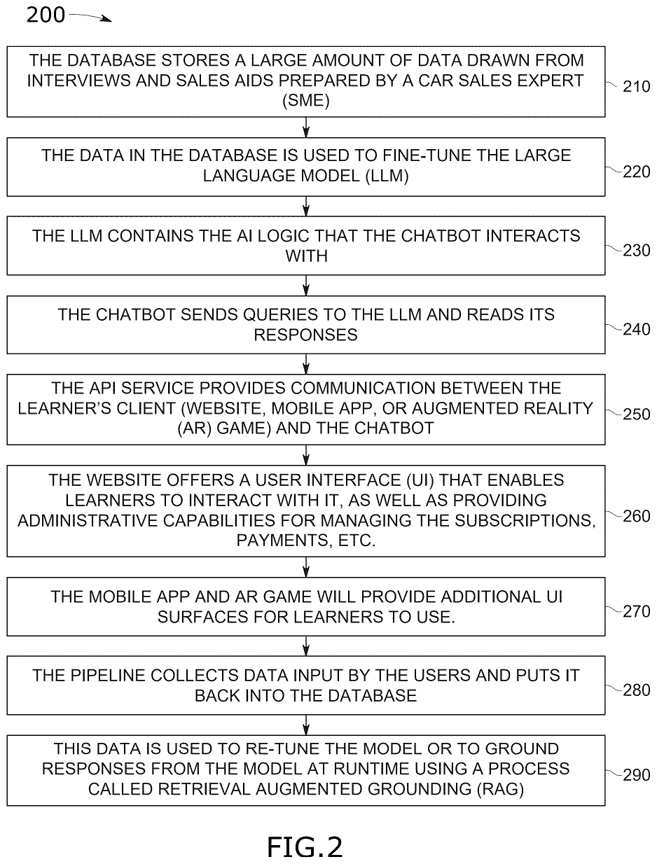

Now, turning to another example, FIG. 2 conceptually illustrates a process for providing an AI-powered car sales training system 200 to teach car sales personnel how to sell cars. As shown in this figure, the process for providing an AI-powered car sales training system 200 comprises several steps in relation to several components of the AI-powered car sales training system. Thus, the AI-powered car sales training system 200 starts with the SME database component, which stores a large amount of data drawn from interviews and sales content prepared by car sales experts (at 210). The car sales experts are referred to as the subject matter experts and, thus, the database is referred to as the SME database. The data in the SME database is used to train and (continually) fine-tune the LLM (at 220). The LLM itself includes AI logic, based on an AI algorithm, with which the chatbot interacts (at 230). The chatbot, in turn, sends prompts (or “queries”) to the LLM and reads the responses generated by the LLM (at 240). The API layer/service provides the communication between the users and the backend, specifically, between the app (which is a car sales learner client to the backend system) and the chatbot (at 250). The app can be, as mentioned above, any type of suitable app such as, without limitation, a website, a mobile app, a desktop app, an AR/VR/XR program or game, or other interlace. Notably, the website offers a user interface (UI) that enables learners to interact with it (at 260), as well as providing administrative capabilities for non-learner users, such as administrators or car sales managers. In this way, sales managers or administrators can manage subscriptions, payments, etc. The mobile app, desktop app, and AR/VR/XR game/program provides additional UI tools, elements, interactive surfaces, etc., for the learners to user while connected (at 270). Meanwhile, the ML pipeline collects data input by the users and puts the data back into the SME database (at 280). Finally, the data is committed to the SME database and used to retrain or refine the LLM or to ground responses from the LLM at runtime using the retrieval augmented grounding (RAG) process (at 290).

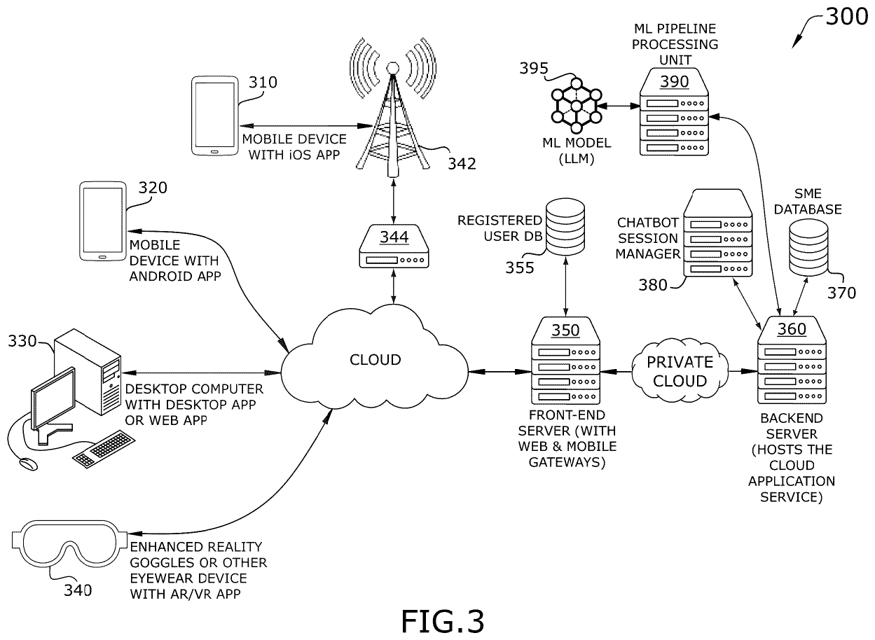

In another example, FIG. 3 conceptually illustrates a cloud-based architecture of an AI-powered car sales training system that hosts a cloud application service 300 (referred to as the “cloud-based AI-powered car sales training system 300”). The cloud-based AI-powered car sales training system 300 shown in this figure demonstrates a plurality of learner/user devices 310-340 that connect over the cloud to the cloud application service. Also, the cloud-based AI-powered car sales training system 300 shown in this figure includes a front-end server 350 with web and mobile gateways, a registered user database 355, a backend server 360 which hosts the cloud application service, the SME database 370, a chatbot session manager 380, an ML pipeline processing unit 390, and the ML model (LLM) 395.

In particular, the plurality of learner/user devices 310-340 comprise an iOS mobile device with iOS app 310, an Android mobile device with Android app 320, a desktop computer with desktop app or web app 330, and an enhanced reality device 340 with the AR/VR app. While the Android mobile device with Android app 320, the desktop computer with desktop app or web app 330, and the enhanced reality device 340 connect to the front-end server 350 over a wireless or wired connection to the Internet (or “cloud”), the iOS mobile device with iOS app 310 connects to a communications tower 342 and a gateway 344, to connect to the front-end server 350. The functionality once connected is similar to the functionality described above and in the descriptions of FIGS. 1-2, above.

In this specification, the terms “app”, “mobile app”, “AR/VR app”, “web app”, or “software” are meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

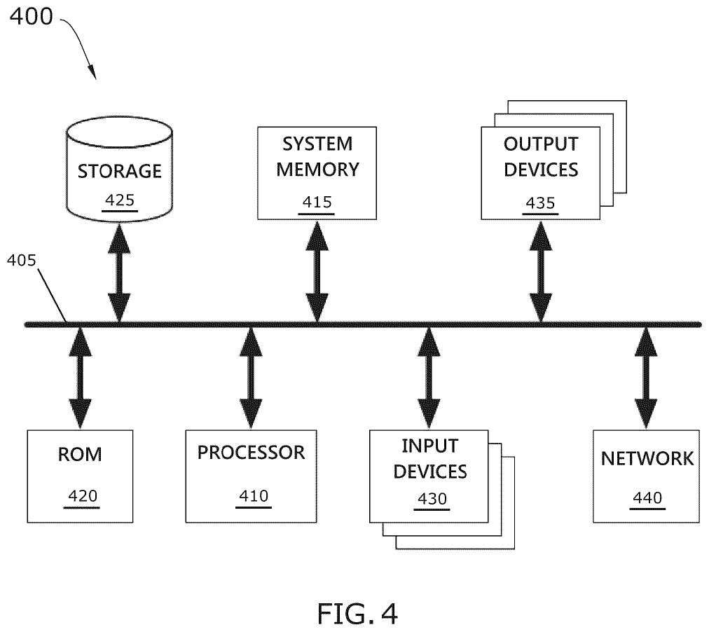

By way of example, FIG. 4 conceptually illustrates an electronic system 400 with which some embodiments of the invention are implemented. The electronic system 400 may be a desktop computer, a laptop, a single board computer (SBC), a personal computer (PC), a mobile device, such as a smartphone or a tablet computing device, an enhanced reality device, such as VR goggles, AR eyewear device, and the like, or any other sort of electronic device capable of communication to a backend cloud application service and providing an interface for a user to interact with a chatbot in the backend. Such an electronic system includes various types of computer readable media and interfaces for various other types of computer readable media. The electronic system 400 shown in this figure includes a bus 405, processing unit(s) 410, a system memory 415, a read-only memory 420, a permanent storage device 425, input devices 430, output devices 435, and a network 440.

The bus 405 collectively represents all system, peripheral, and chipset buses that communicatively connect the numerous internal devices of the electronic system 400. For instance, the bus 405 communicatively connects the processing unit(s) 410 with the read-only memory 420, the system memory 415, and the permanent storage device 425.

From these various memory units, the processing unit(s) 410 retrieves instructions to execute and data to process in order to execute the processes of the invention. The processing unit(s) may be a single processor or a multi-core processor in different embodiments.

The read-only-memory (ROM) 420 stores static data and instructions that are needed by the processing unit(s) 410 and other modules of the electronic system 400. The permanent storage device 425, on the other hand, is a read-and-write memory device. This device is a non-volatile memory unit that stores instructions and data even when the electronic system 400 is off. Some embodiments of the invention use a mass-storage device (such as a magnetic or optical disk and its corresponding disk drive) as the permanent storage device 425.

Other embodiments use a removable storage device (such as a flash drive) as the permanent storage device 425. Like the permanent storage device 425, the system memory 415 is a read-and-write memory device. However, unlike storage device 425, the system memory 415 is a volatile read-and-write memory, such as a random access memory. The system memory 415 stores some of the instructions and data that the processor needs at runtime. In some embodiments, the invention's processes are stored in the system memory 415, the permanent storage device 425, and/or the read-only 420. From these various memory units, the processing unit(s) 410 retrieves instructions to execute and data to process in order to execute the processes of some embodiments.

The bus 405 also connects to the input and output devices 430 and 435. The input devices enable the user to communicate information and select commands to the electronic system. The input devices 430 include alphanumeric keyboards and pointing devices (also called “cursor control devices”). The output devices 435 display images generated by the electronic system 400. The output devices 435 include printers and display devices, such as liquid crystal displays (LCD), organic light emitting diode (OLED) displays, and enhanced reality eyewear devices (such as VR goggles, AR eyewear devices, etc.). Some embodiments include devices such as a touchscreen that functions as both input and output devices.

Finally, as shown in FIG. 4, bus 405 also couples electronic system 400 to a network 440 through a network adapter (not shown). In this manner, the computer can be a part of a network of computers (such as a local area network (“LAN”), a wide area network (“WAN”), or an intranet), or a network of networks (such as the Internet), an example of which is described above by reference to FIG. 3. Additionally, any or all components of electronic system 400 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

While the invention has been described with reference to numerous specific details, one of ordinary skill in the art will recognize that the invention can be embodied in other specific forms without departing from the spirit of the invention. For instance, FIG. 2 conceptually illustrates a process. The specific operations of the process may not be performed in the exact order shown and described. Specific operations may not be performed in one continuous series of operations, and different specific operations may be performed in different embodiments. Furthermore, the process could be implemented using several sub-processes, or as part of a larger macro process. Additionally, the AI-powered car sales training system can be adapted to provide a learning experience in other industries and fields. Because the expertise used to create the learning experience relies heavily on the input from the industry SME, other types of expertise and data can be used to fine-tune the model. Thus, a SME from another industry outside of car sales could provide training information that would result in a different field. Thus, one of ordinary skill in the art would understand that the invention is not to be limited by the foregoing illustrative details, but rather is to be defined by the appended claims.

I claim:

1. An artificial intelligence (AI)-powered car sales training system comprising:
a subject matter expert (SME) database that stores raw information (SME car sales data) from a car sales expert, wherein the SME database is a cloud database that is hosted in the cloud by a cloud provider;
a large-language model (LLM) that has been fine-tuned and trained on the SME car sales data and stored in connection with the cloud provider;
a chatbot that mediates interactions between each user and the LLM, wherein the chatbot is hosted on the cloud provider;
an application programming interface (API) service that receives data from the device operated by the user, passes the data to the chatbot, and then provides the chatbot's response back to the device operated by the user;
a web and mobile gateway configured to present a website for browser connections, web app for browser and mobile device connections, and a mobile app for connections from mobile devices, wherein the mobile app is configured to operate on one of iOS and Android;
an augmented reality (AR) program game available for interaction; and
an AI-based, machine learning (ML) pipeline hosted on the cloud provider.
